(19) United States
(12) Patent Application Publication
(10) Pub. No.: US 2015/0266259 A1
(43) Pub. Date: Sep. 24, 2015

(54) CONTAINER SECURITY DEVICE WITH AUTHENTICATION PANEL

(71) Applicant: Michael Flynn, Newport Beach, CA (US)

(72) Inventor: Michael Flynn, Newport Beach, CA (US)

(21) Appl. No.: 14/221,561

(22) Filed: Mar. 21, 2014

(51) Int. Cl. B32B 3/10

(52) U.S. Cl. CPC B32B 3/10

(57) ABSTRACT

A simple and effective device is provided for securing clear liquid containers from unwanted usage of the liquid contents. The device is particularly suited for preventing or detecting unwanted consumption of alcoholic beverages. The device comprises a flexible rectangular body having a pull tab for device removal, an adhesive bottom face, and a top face having an authentication panel surrounded by a security pattern. The top face contains a level marker above the authentication panel. The marker to line is aligned with the liquid level in the beverage container. The authentication panel allows the user to apply a unique marking such as a signature that cannot be replicated. The device cannot be removed without disrupting the security pattern and thus evidencing the tampering. If the liquid in the beverage container is consumed, then the liquid level will fall below the level marker and tampering will be evident.

### RELATED U.S. APPLICATION DATA

This application claims priority to Provisional Application No. 61/803,795, filed Mar. 21, 2013.

### FIELD OF THE INVENTION

The present invention relates to security devices for preventing unwanted access to various containers.

### BACKGROUND OF THE INVENTION

It is often desired to secure beverage containers to prevent or detect unwanted access. A particular need exists to secure alcoholic beverage containers from unwanted tampering and consumption by minors. For example, many households have alcoholic beverages and parents are concerned about consumption by minor children, particularly when unattended, given that minors may attempt to consume alcoholic beverages in the house when unsupervised. For most households, it is impractical or impossible to secure or hide alcoholic beverages to prevent access by minors. Moreover, it can be difficult to monitor the content level of multiple alcoholic beverage bottles and parents often neglect to properly monitor such levels. There is a need for a simple and inexpensive way to detect and thus discourage unwanted tampering with alcoholic beverage containers.

### SUMMARY OF THE INVENTION

A simple and effective device is provided for securing clear liquid containers from unwanted usage of the liquid contents. The device is particularly suited for preventing or detecting unwanted consumption of alcoholic beverages. The device comprises a flexible rectangular body having a pull tab for device removal, an adhesive bottom face, and a top face having an authentication panel surrounded by a security pattern. The top face contains a level marker above the authentication panel. The marker line is aligned with the liquid level in the beverage container. The authentication panel allows the user to apply a unique marking such as a signature that cannot be replicated. The device cannot be removed without disrupting the security pattern and thus evidencing the tampering. If the liquid in the beverage container is consumed, then the liquid level will fall below the level marker and tampering will be evident.

### BRIEF DESCRIPTION OF THE DRAWINGS

FIG. 1 illustrates top, bottom and cross-section views of the container security device of the present invention.

FIG. 2 illustrates the container security device of the present invention being applied to, and removed from, a bottle.

### DETAILED DESCRIPTION

The present invention provides an easy, inexpensive yet effective means of securing alcoholic beverages to discourage and detect unwanted tampering.

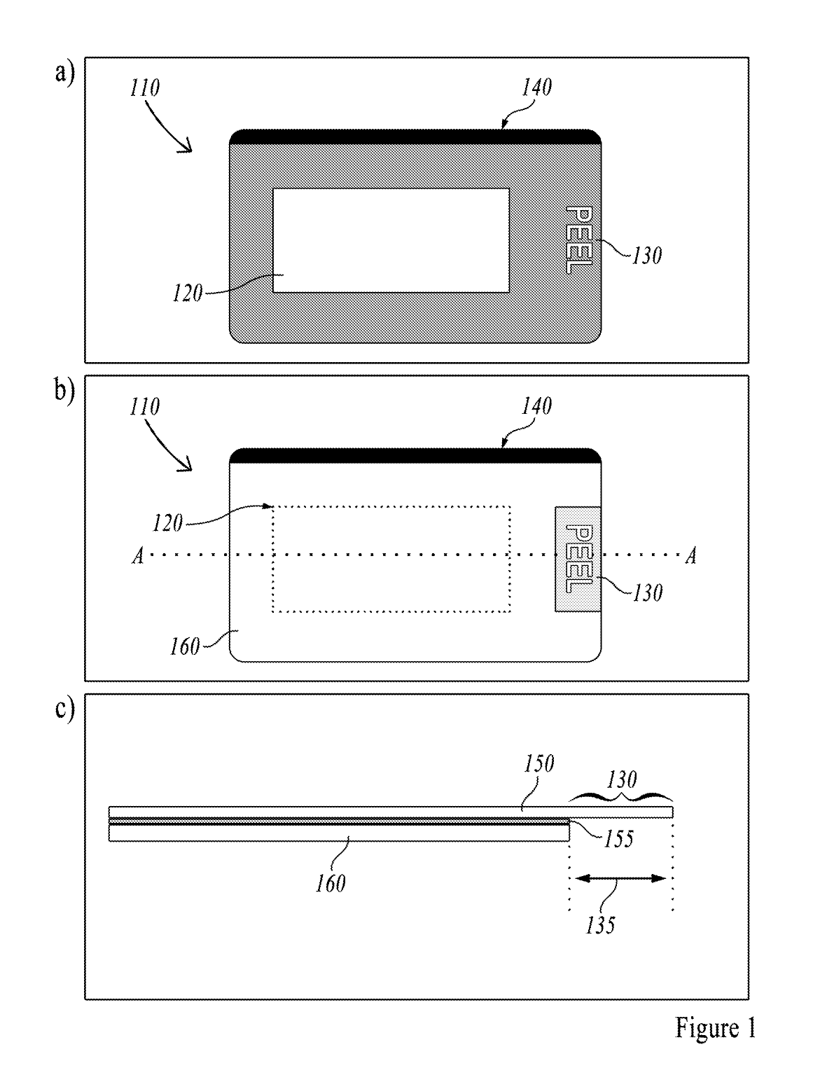

FIGS. 1A-C illustrate top, bottom, and side views of an exemplary embodiment of the present invention. The container security device is particularly suited for preventing or detecting unwanted access to alcoholic containers (i.e. bottled spirits). In an exemplary embodiment, the device comprises a rectangular body having a top face and bottom face. However, other shapes (e.g. elliptical, circular) could be utilized while keeping within the spirit of the invention. As shown in FIG. 1A, the top face of the container security device 110 has an upper edge which features a level marker 140 to be aligned with the liquid level in the beverage container. The top face of the device includes a writable patch or authentication panel 120 that allows the user to make a unique marking (e.g. signature). By doing so, the device becomes unique and cannot be replaced in an attempt to conceal tampering. The right edge of the device contains a pull tab 130, the underside (bottom surface) of which has no adhesive layer as shown in FIG. 1C. FIG. 1B shows a bottom view of the device 110, showing the underside of the pull tab 130, as well as the adhesive security pattern 125 which covers the majority of the device's bottom surface. Upon removal of the container security device 110, the security pattern would be damaged and tampering would be evident. The unique nature of the security pattern prevents any potential tampering from being covered up by the application of a new device.

FIG. 1C shows a cross-section of the container security device 110 taken through line “A” shown in FIG. 1B. The device is comprised of three layers: a printable laminate 150 (top layer), adhesive layer 155 (intermediate layer), and adhesive cover 160 (bottom layer). The authentication panel on printable laminate 150 provides another means of applying a distinct identifying mark to the device. Adhesive layer 155 is lined with an adhesive film on its bottom surface that is in contact with the adhesive cover 160. Embedded within the adhesive film of layer 155 is a security pattern. Thus, the adhesive layer 155 may also be referred to as the security pattern layer. The adhesive cover 160 is a thin plastic or paper cover that is removed to expose the adhesive film of adhesive layer 155 prior to application of the security device 110, as commonly found on devices with adhesive or sticker surfaces. It covers the majority of the device's bottom surface, up to the edge of pull tab 130. Dimension arrow 135 indicates the area where adhesive layer 155 and adhesive cover 160 terminate and only laminate layer 150 remains, i.e. the portion of laminate layer 150 that acts as the pull tab 130. Thus, the pull tab 130 is an adhesive-free edge portion of the laminate layer 150 that can be grasped by the user in order to peel off the adhesive cover 160 to expose the adhesive layer 155 (which contains the security pattern 125) for application to the surface of a beverage container.

The security pattern 125 may constitute a repeating text pattern (e.g. “OPEN/VOID”) as shown in FIG. 1B, or an image, as long as it is readily apparent if a portion of the image or pattern is absent or faded. The security pattern is configured such that it is damaged or broken when the adhesive portion is removed from a surface, i.e. the side of a beverage bottle. Thus, tampering is readily evident by the damaged security pattern. Moreover, the nature of the adhesive bond between the device and the container is such that once the bond is broken, it cannot be re-applied without the tampering being visibly apparent by the lack of adhesion. Similarly, a new device cannot be applied without attempting to re-create the authentication mark applied by the user (e.g. signature) to the authentication panel or printable clear substrate—a difficult task which is unlikely to be attempted. This serves as a deterrent to tampering with the container contents.

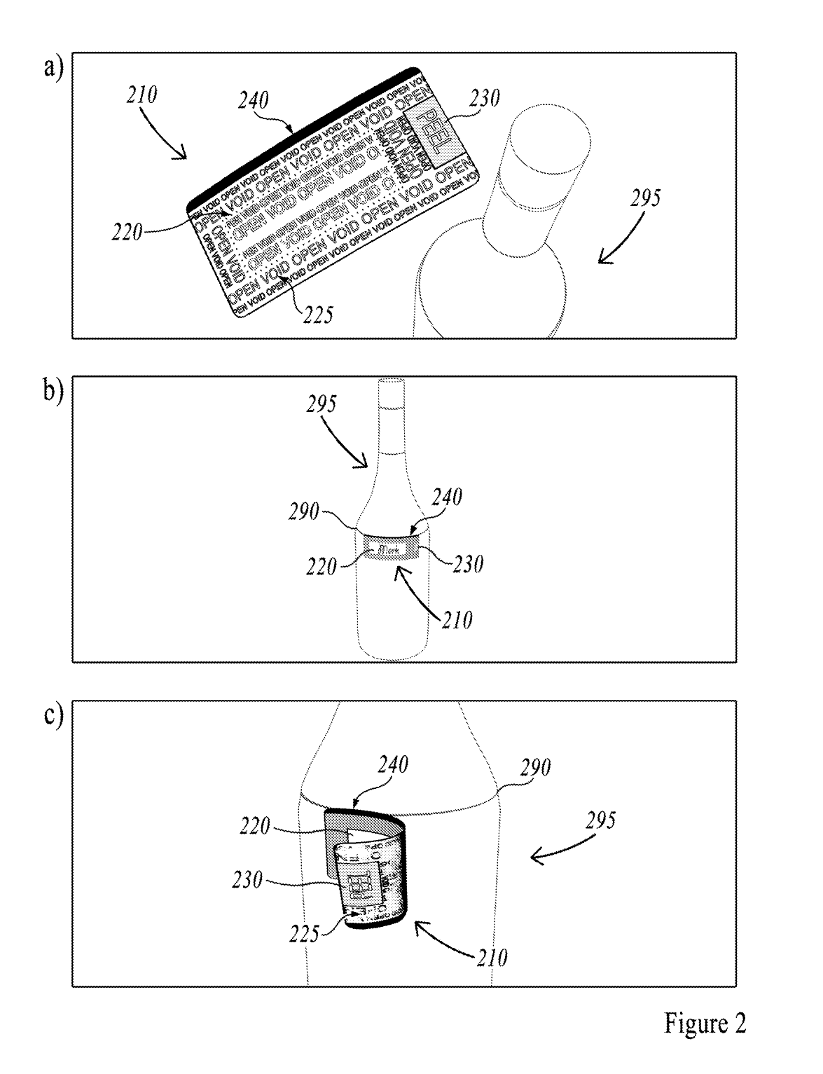

FIGS. 2A-C show the device being applied to a beverage container, then partially removed from it. In FIG. 2A, the container security device 210 has the adhesive portion of its bottom face exposed via the removal of the adhesive cover 160 depicted in FIG. 1C. It is prepared for application to an alcohol-containing bottle 295. FIG. 2B depicts this application, whereby the security device 210 is adhered to the bottle with its level marker 240 aligned with the bottle's liquid level 290. Once the device is affixed to the bottle in such a manner, consumption of the liquid cannot occur without detection. If liquid is removed, it will be apparent because the liquid level will be below the marker line. Moreover, the device cannot be removed from the container without disrupting the security pattern 225 and making tampering readily evident. FIG. 2C depicts an instance of said tampering, whereby the security device 210 has been peeled from the surface of the bottle 295. The resultant damage to the security pattern 225 is shown, wherein the pattern becomes broken and/or smudged in many areas. At this point, the adhesive portion of the device will no longer properly adhere to the bottle's surface, which also makes tampering evident. Additionally, the complete removal of the device for the purpose of replacing it with another device would be futile, as the replacement device would not possess the authentication markings made in the authentication panel 220.

While there have been described herein what are considered to be preferred and exemplary embodiments of the present invention, other modifications of the invention shall be apparent to those skilled in the art from the teachings herein. For example, the relative dimensions of the device may be altered while keeping within the spirit and teachings of the invention. It is therefore desired to be secured, in the appended claims all such modifications as fall within the spirit and scope of the invention.

What is claimed is:

1. A tamper detection device for beverage containers comprising:
a laminate layer, said laminate layer having a top surface with a top edge that is highlighted by a linear marking, said laminate layer also having an authentication an adhesive layer affixed to a bottom surface of the laminate layer, the adhesive layer having a security pattern embedded therein;
an adhesive cover that is coextensive with, and affixed to, the bottom surface of the adhesive layer; and
wherein the adhesive layer is not coextensive with the laminate layer, such that an edge portion of the laminate layer is not covered by the adhesive laver, said edge portion serving as a pull tab to facilitate removal of the adhesive cover from the adhesive layer.

2. The device of claim 1 wherein the security pattern becomes visibly damaged upon removal of the device from the surface of a beverage container.

3. The device of claim 1 wherein the laminate layer is made of plastic or paper.

4. The device of claim 1 wherein the adhesive layer is made of a polymer film.

5. A tamper detection device for beverage containers comprising:
a laminate layer, said laminate layer having an authentication panel;
an adhesive layer affixed to a bottom surface of the laminate layer, the adhesive layer having a security pattern embedded therein; and
an adhesive cover that is coextensive with, and affixed to, the bottom surface of the adhesive layer.

6. The device of claim 1 wherein the security pattern becomes visibly damaged upon removal of the device from the surface of a beverage container.

7. The device of claim 1 wherein the laminate layer is made of plastic or paper.

8. The device of claim 1 wherein the adhesive layer is made of a polymer film.
